(19) United States
(12) Patent Application Publication
(10) Pub. No.: US 2015/0291793 A1
(43) Pub. Date: Oct. 15, 2015

(54) STABILIZED MOULDING COMPOUNDS CONSISTING OF POLYAMIDE AND ASA-COPOLYMERS

(71) Applicants: Rolf Minkwitz, Mannheim (DE); Martin Weber, Maikammer (DE); Marko Blinzler, Mannheim (DE); Wenke Wollny, Freinsheim (DE)

(72) Inventors: Rolf Minkwitz, Mannheim (DE); Martin Weber, Maikammer (DE); Marko Blinzler, Mannheim (DE); Wenke Wollny, Freinsheim (DE)

(73) Assignee: STYROLUTION GMBH, Frankfurt am Main (DE)

(21) Appl. No.: 14/347,786

(22) PCT Filed: Sep. 3, 2012
(86) PCT No.: PCT/EP2012/067073

§ 371 Date: Jul. 8, 2014

(30) Foreign Application Priority Data
Sep. 29, 2011 (EP) 11183224.2

(51) Int. Cl. C08L 77/02; D01F 6/30; D01F 6/36; C08J 5/18; D01F 6/42

(52) U.S. Cl. CPC C08L 77/02; C08J 5/18; D01F 6/42; D01F 6/36; D01F 6/30; C08J 2377/02; C08J 2425/12; C08J 2413/00; C08J 2423/08; C08L 2203/12; C08L 2203/16; C08L 2207/04; C08L 2205/025; C08L 2205/035

(57) ABSTRACT

Thermoplastic molding compositions comprising:
a) 3 to 91.8 wt % of at least one polyamide, as component A,
b) 3 to 91.8 wt % of one or more styrene copolymers B without any maleic anhydride-derived units,
c) 3 to 91.8 wt % of one or more impact-modifying grafted rubbers C,
d) 0.2 to 1.5 wt % of a compound of formula (I), as component D:

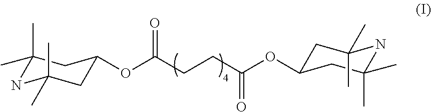

e) 0 to 0.9 wt % of a mixture of formula (II), as component E:

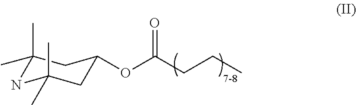

f) 0 to 0.9 wt % of a further stabilizer component F,
g) 1 to 25 wt % of one or more styrene copolymers G,
h) 1 to 30 wt % of one or more further rubbers,
exhibit improved weathering resistance.

The present invention relates to thermoplastic molding compositions comprising at least one polyamide, at least one styrene copolymer and at least one impact-modifying grafted rubber without olefinic double bonding in the rubber phase. The invention also relates to the production of stabilized molding compositions comprising polyamide and copolymers of acrylonitrile, styrene and acrylic esters (ASA).

Stabilized thermoplastic molding compositions of various kinds are well known. Polymeric mixtures (polyblends) of polyamide and styrene polymers are widely used because their performance characteristics—impact toughness, flowability and chemical resistance, in particular—are favorable for many applications. However, there are some applications for which known polyblends of polyamide and styrene polymer are insufficiently UV light resistant.

EP-A 1 263 855 discloses stabilized molding compositions which, in addition to a polyethylene or polypropylene or a copolymer thereof, may further comprise compounds of hereinbelow recited formulae (I), (II), (III), (IV), (V) or (VI) of the present invention in combination with an acrylate rubber-modified vinylaromatic copolymer (ASA, acrylonitrile/styrene/acrylate) or polycarbonate in amounts up to 1.5%. These molding compositions are disadvantageous because they lack heat resistance,

U.S. Pat. No. 4,692,486 discloses stabilizer mixtures comprising compounds of formulae (I) and (III) of the present invention for polypropylene, polyurethane and polystyrene, wherein the individual stabilizer components are each employed at not more than 0.1 wt %. Again, these mixtures are disadvantageous because the molding compositions lack heat resistance.

DE-A 103 16 198 discloses stabilizer mixtures for different types of thermoplastic polymers, such as polypropylene for example. The stabilizer mixtures are ternary mixtures. A multiplicity of possible generic and specific compounds are described for each of the three components of this ternary mixture. A stabilizer mixture comprising compounds of formulae (I), (II) and (III) of the present invention is described as merely one of many possibilities,

Each of the three stabilizer components may preferably be present in amounts of 0.05 to 1 wt %, based on the organic material. These mixtures are disadvantageous because the multi-axial toughness declines severely during weathering (testing at various temperatures, humidities, etc.).

It is an object of the present invention to provide improved molding compositions on the basis of polyamide and acrylonitrile/styrene/acrylate molding compositions.

The present invention accordingly provides novel and improved thermoplastic molding compositions comprising as components (or consisting of):
a) 3 to 91.8 wt % of at least one polyamide, as component A,
b) 3 to 91.8 wt % of one or more styrene copolymers without any maleic anhydride-derived units, as component B,
c) 3 to 91.8 wt % of one or more impact-modifying grafted rubbers without olefinic double bonding in the rubber phase, as component C,
d) 0.2 to 1.5 wt % of a compound of formula (I), as component D

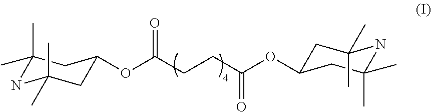

e) 0 to 0.9 wt % of a mixture of formula (II), as component E

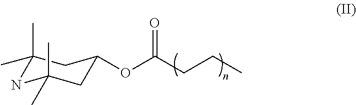

where n is 2 to 20, in p0articular

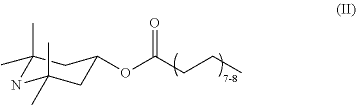

f) 0 to 0.9 wt % of a compound of formula (III), as component F

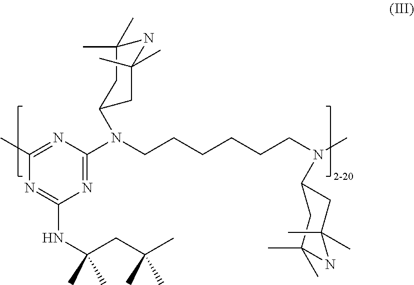

or 0 to 0.9 wt % of a compound of formula (IV)

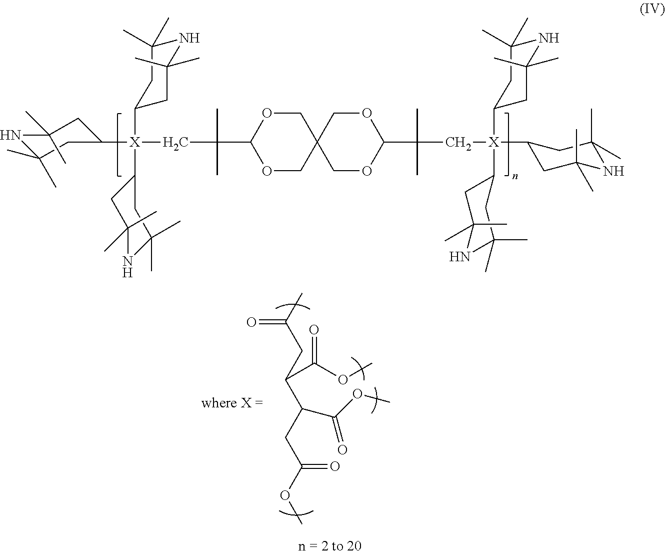

or 0 to 0.9 wt % of a compound of formula (V)

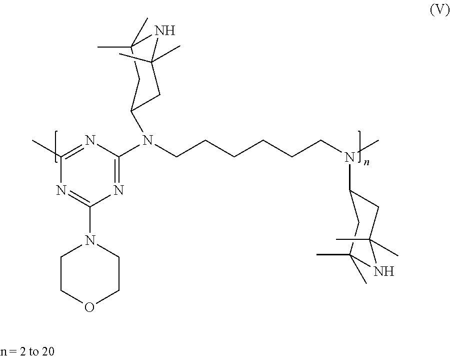

or 0 to 0.9 wt % of a compound of formula (VI):

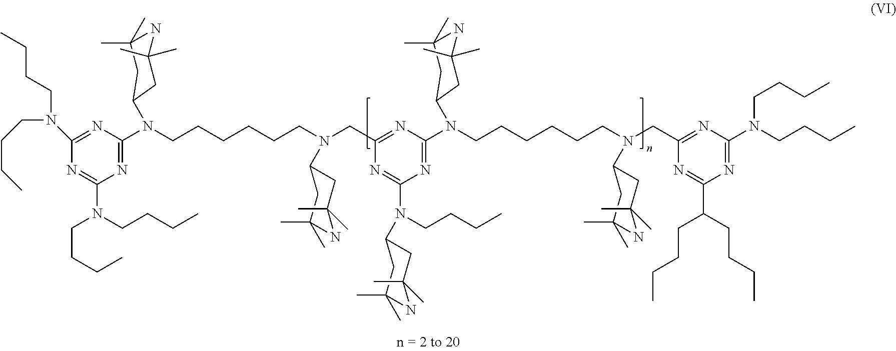

g) 1 to 25 wt % of one or more styrene copolymers which, based on overall component G, include from 0.5 to 5 wt % of maleic anhydride-derived units, as component G,
h) 1 to 30 wt % of one or more further rubbers based on olefinic monomers without core-shell construction and with at least 0.1 wt % of functional monomers, as component H,
i) 0to 40 wt % of one or more added-substance materials other than components D, E, F, G, and H, as component I, and
j) 0 to 50 wt % of fibrous or particulate fillers, as component J,

with the proviso that when component E amounts to 0 wt % (i.e., no component E is present), at least one of the components of formulae (III), (IV), (V) or (VI) is present in an amount of 0.01 to 0.9 wt %, preferably 0.1 to 0.8 wt % and more preferably 0.2 to 0.8 wt %, wherein the wt % are each based on the overall weight of components A to J, and these add up to 100 wt %.

The invention further provides thermoplastic molding compositions which are characterized in that the swelling index of component C is in the range from 6 to 20.

The invention further provides thermoplastic molding compositions which are characterized in that component B comprises a copolymer of acrylonitrile, styrene and/or α-methylstyrene, phenylmaleimide, methyl methacrylate or mixtures thereof,

The invention further provides thermoplastic molding compositions which are characterized in that component C comprises a mixture of an acrylate-styrene-acrylonitrile (ASA) graft polymer comprising 55 to 80 wt %, based on C, of an elastomer-crosslinked acrylic ester polymer C1 and 45 to 25 wt %, based on C, of a graft sheath C2 formed from a vinylaromatic monomer and one or more polar, copolymerizable, ethylenically unsaturated monomers, optionally a further copolymerizable, ethylenically unsaturated monomer in a weight ratio of from 80:20 to 65:35.

The invention further provides thermoplastic molding compositions which are characterized in that C1 comprises from 0.01 to 20 wt %, preferably from 0.1 to 5 wt %, of a crosslinking monomer, preferably butylene diacrylate, divinylbenzene, butanediol dimethacrylate, trimethylolpropane tri(meth)acrylate, diallyl methacrylate, diallyl maleate, diallyl fumarate, triallyl methacrylate, triallyl isocyanurate, more preferably diallyl phthalate, allyl methacrylate and/or dihydrodicyclopentadienyl acrylate.

The invention further provides thermoplastic molding compositions which are characterized in that the average particle diameter of component C is between 50 to 1200 nm,

The invention further provides thermoplastic molding compositions which are characterized in that the weight ratio of components D and E is in the range from 3:1 to 1:1 and the weight ratio of components E and F is in the range from 2:1 to 0.5:1.

The invention further provides thermoplastic molding compositions which are characterized in that component C1 comprises from 2 to 99 wt % of butyl acrylate.

The invention further provides thermoplastic molding compositions which are characterized in that the vinylaromatic component in C2 comprises styrene or α-methylstyrene.

The invention further provides thermoplastic molding compositions which are characterized in that the ethylenically unsaturated component in C2 comprises acrylonitrile and/or alkyl methacrylates and/or alkyl acrylates having C₁-C₈ alkyl,

The invention further provides thermoplastic molding compositions which are characterized in that component C comprises a rubber in monomodal or bimodal particle size distribution.

The invention further provides thermoplastic molding compositions which are characterized in that component G includes from 1.0 to 2.5 wt % of maleic anhydride-derived units.

The invention further provides thermoplastic molding compositions which are characterized in that component G includes from 1.7 to 2.3 wt % of maleic anhydride-derived units.

The invention further provides thermoplastic molding compositions which are characterized in that component A includes from 0.05 to 0.5 wt % of triacetonediamine (TAD) end groups.

The invention further provides thermoplastic molding compositions which are characterized in that component H is a copolymer formed from the following components:
h1) 35 to 89.95 wt % of ethylene, as component h1,
h2) 10 to 60 wt % of 1-octene, 1-butene, propene or mixtures thereof, as component h2, and
h3) 0.05 to 5 wt % of functional monomers, wherein the monomers bear functional groups selected from carboxylic acid, carboxylic anhydride, carboxylic ester, carboxamide, carboximide, amino, hydroxyl, epoxy, urethane or oxazoline groups or mixtures thereof.

The invention further provides a process for producing a thermoplastic molding composition as described above, said process being characterized in that components A, B, C, D, G and H and also, optionally, E, F, I and J are mutually mixed with one another in any desired order at temperatures of 100 to 300° C. and a pressure of 1 to 50 bar, then kneaded and extruded.

The process for producing thermoplastic molding compositions may be carried out by first premixing a portion of component C with a portion of component B to form a masterbatch in the ratio of from 1:1 to 1:2 and then mixing said masterbatch with further components A to J to form the thermoplastic molding composition.

The invention further provides for the use of thermoplastic molding compositions as described above for producing molded articles, self-supporting films or sheets, or fibers. The use of the thermoplastic molding compositions for producing molded articles for automotive components or parts of electronic equipment is particularly preferred.

The invention also provides molded articles, fibers or self-supporting films or sheets from a thermoplastic molding composition as described.

The improved thermoplastic molding compositions preferably comprise at least one component D and at least one component E and also optionally an additional stabilizer component F.

The invention also provides a process for producing the molding compositions described, their use for producing self-supporting films or sheets, molded articles or fibers, and also these self-supporting films or sheets, molded articles or fibers.

The specific selection of the individual components and of their specific proportions is essential to the present invention and endows the molding compositions of the present invention with an improved weathering resistance, i.e., an improved heat, light and/or oxygen resistance, over the known stabilized molding compositions.

The molding compositions, articles, processes and uses provided by the present invention will now be more particularly described.

The molding compositions of the present invention each comprise, based on the overall weight of components A, B, C, D, E, F, G, H, I and J, which totals ail together 100 wt %,
a) 3 to 91.8 wt %, often 10 to 75 wt %, of at least one polyamide, as component A,
b) 3 to 91.8 wt %, preferably 10 to 75 wt %, often 20 to 70 wt % of component B,
c) 3 to 91.8 wt %, preferably 10 to 50 wt %, more preferably 15 to 40 wt % of component C,
d) 0.2 to 1.5 wt %, preferably 0.2 to 1.2 wt %, more preferably 0.3 to 1.1 wt % of component D,
e) 0 to 0.9 wt %, preferably 0.2 to 0.8 wt %, more preferably 0.2 to 0.7 wt % of component E, with the proviso that when component E amounts to 0 wt % (i.e., no component E is present), component F amounts to 0.01 to 0.9 wt %, preferably 0.1 to 0.8wt %, more preferably 0.2 to 0.8 wt % of one of compounds III, IV, V or VI,
f) 0 to 0.9 wt %, preferably 0.1 to 0.8 wt %, more preferably 0.2 to 0.8 wt % of component F,
g) 1 to 25 wt %, preferably 2 to 10 wt %, more preferably 3 to 7 wt % of component G,
h) 1 to 30 wt %, preferably 1.0 to 10 wt %, often 1.5 to 10 wt %, more preferably 2 to 5 wt % of component H, and
i) 0 to 40 wt %, preferably 0 to 30 wt %, in particular 0 to 17 wt % of component I, and
j) 0 to 50 wt %, preferably 0 to 25 wt %, in particular 0 to 8 wt % of component J.

The weight ratio of component D to component E is generally in the range from 4:1 to 0.25:1, preferably in the range from 4:1 to 1:1 and more preferably in the range from 3:1 to 1:1.

The component E:F weight ratio is generally in the range from 2:1 to 0.5:1.

Frequently used molding compositions comprise (or consist of):
a) 10 to 75 wt % of at least one polyamide, as component A,
b) preferably from 10 to 75 wt % of component B,
c) 15 to 40 wt % of component C,
d) 0.3 to 1.1 wt % of component D,
e) 0.2 to 0.7 wt % of component E,
f) 0 to 0.9 wt %, preferably 0.1 to 0.8 wt %, more preferably 0.2 to 0.8 wt % of component F,
g) 3 to 7 wt % of component G,
h) 1 to 30 wt %, preferably from 1.0 to 10 wt % of component H.

Component A:

Component A of the thermoplastic molding compositions according to the present invention comprises one or more polyamides having preferably, based on overall component A, from 0.05 to 0.5 wt %, more preferably 0.1 to 0.2 wt % of triacetonediamine (TAD) end groups.

Component A is comprised in the molding compositions in an amount of 3 to 91.8 wt %, often from 10 to 75 wt %, often also 30 to 60 wt %. Absent any indication to the contrary, the wt % are based on the overall molding composition.

Component A may comprise TAD-free polyamides, TAD-containing polyamides or else mixtures of polyamides having TAD end groups with polyamides without TAD end groups. All together, based on component A, from 0.1 to 0.2 wt % triacetonediamine end groups may preferably be present. Preferably from 0.14 to 0.18 wt % of TAD end groups is present, in particular from 0.15 to 0.17 wt % of TAD end groups.

Component A according to the present invention comprises a polyamide with at least one end group that is derivable from the piperidine compound TAD. Mixtures of two or more different polyamides can also be used as component A. For instance, polyamides which differ in their core structure but have the same end group can be used. But it is also possible to employ polyamides having the same core scaffold and end groups that derive from different piperidine compounds. It is further possible to use mixtures of polyamides having different content levels of end groups that derive from piperidine compounds.

By polyamides are meant homopolymers or copolymers of synthetic long-chain polyamides having recurring amide groups as an integral part of the main polymer chain. Examples of polyamides of this type are inter alia nylon-6 (polycaprolactam), nylon-6,6 (polyhexamethyleneadipamide), nylon-4,6 (polytetramethyleneadipamide), nylon-5,10 (polypentamethyleneadipamide), nylon-6,10 (polyhexamethylenesebacamide), nylon-7 (polyenantholactam), nylon-11 (polyundecanolactam), nylon-12 (polyundecanolactam). These polyamides are known to bear the generic name nylon.

Polyamides are obtainable by two methods in particular. In the polymerization from dicarboxylic acids and diamines and also in the polymerization from amino acids, the amino and carboxyl end groups of the starting monomers or oligomers react with one another to form an amide group and water. The water may be subsequently removed from the polymer mass. In the polymerization from carboxamides, the amino and amide end groups of the starting monomers or oligomers react with one another to form an amide group and ammonia. The ammonia may subsequently be removed from the polymer mass.

Useful starting monomers or oligomers for producing polyamides include for example:
(1) C₂-C₂₀, preferably C₃-C₁₈ amino acids, such as 6-aminocaproic acid, 11-aminoundecanoic acid, and also their dimers, trimers, tetramers, pentamers or hexamers,
(2) C₂-C₂₀ amino acid amides, such as 6-aminocaproamide, 11-aminoundecanoamide and also their dimers, trimers, tetramers, pentamers or hexamers,
(3) reaction products of (3a) C₂-C₂₀, preferably C₂-C₁₂ alkyldiamines, such as tetramethylenediamine or preferably hexamethylenediamine, with (3b) a C₂-C₂₀, preferably C₂-C₁₄ aliphatic dicarboxylic acid, such as sebacic acid, decanedicarboxylic acid or adipic acid, and also their dimers, trimers, tetramers, pentamers hexamers,
(4) reaction products of (3a), with (4b) a C₈-C₂₀, preferably C₈-C₁₂ aromatic dicarboxylic acid or its derivatives, for example chlorides, such as 2,6-naphthalenedicarboxylic acid, preferably isophthalic acid or terephthalic acid, and also their dimers, trimers, tetramers, pentamers or hexamers,

(5) reaction products of (3a), with (5b) a C₉-C₂₀, preferably C₉-C₁₈ arylaliphatic dicarboxylic acid or its derivatives, for example chlorides, such as o-, m- or p-phenylenediacetic acid, and also their dimers, trimers, tetramers, pentamers hexamers,
(6) reaction products of (6a) C₆-C₂₀, preferably C₆-C₁₀ aromatic diamines, such as, m- or p-phenylenediamine, with (3b) and also their dimers, trimers, tetramers, pentamers or hexamers,
(7) reaction products of (7a) C₇-C₂₀, preferably C₈-C₁₈ arylaliphatic diamines, such as m- p-xylylenediamine, with (3b) and also their dimers, trimers, tetramers, pentamers or hexamers,
(8) monomers or oligomers of a C₂-C₂₀, preferably C₂-C₁₈ arylaliphatic or preferably aliphatic lactam, such as enantholactam, undecanolactam, dodecanolactam or caprolactam,

and also homopolymers, copolymers or mixtures of such starting monomers or oligomers.

Preference is given to those starting monomers or oligomers which on polymerization lead to the polyamides nylon-6; nylon-6,6; nylon-4,6; nylon-5,10; nylon-6,10; nylon-7; nylon-11; nylon-12; in particular to nylon-6 and nylon-6,6.

The optionally present triacetonediamine (TAD) end groups derive from 4-amino-2,2;6,6-tetramethylpiperidine. The attachment of the TAD to the polyamide may be via an amino or carboxyl group. So 4-carboxy-2,2;6,6-tetramethylpiperidine may also be concerned for example.

The process of producing polyamides A is known per se or may be effected according to methods known per se. Thus, the chain growth addition polymerization or the condensation polymerization of the starting monomers, for example in the presence of the piperidine compounds, may be carried out under customary processing conditions, in which case the reaction can be carried out as a continuous operation or as a batch operation. The piperidine compounds, if present, can also be combined with a chain transfer agent as typically used for the production of polyamides. Particulars regarding suitable methods are found for example in WO 1995/28443, WO 1999/41297 or DE-A 198 12 135, The TAD compound is attached to the polyamide by reacting at least one of the amide-forming R⁷ groups. The secondary amino groups of the piperidine ring systems do not react here because of steric hindrance.

It is also possible to use polyamides formed by copolycondensation of two or more of the abovementioned monomers or components thereof,

e.g., copolymers of adipic acid, isophthalic acid or terephthalic acid and hexamethylenediamine, or copolymers of caprolactam, terephthalic acid and hexamethylenediamine.

Partly aromatic copolyamides of this type comprise from 40 to 90 wt % of units derived from terephthalic acid and hexamethylenediamine. A small proportion of the terephthalic acid, preferably not more than 10 wt % of total aromatic dicarboxylic acids employed, may be replaced by isophthalic acid or other aromatic dicarboxylic acids, preferably those in which the carboxyl groups are para disposed. One partial aromatic polyamide is nylon-9T; it derives from nonanediamine and terephthalic acid.

The monomers used may also be diamines, such as hose of general formula (VII):

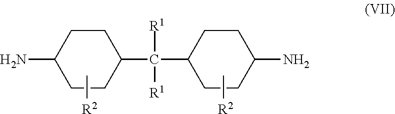

in which

R¹ is hydrogen or C₁-C₄ alkyl,

R² is a C₁-C₄ alkyl or hydrogen, and

R³ is a C₁-C₄ alkyl or hydrogen.

Particularly preferred diamines of formula (VII) are bis(4-aminocyclohexyl)methane, bis(4-amino-3-methylcyclohexyl)methane, bis(4-aminocyclohexyl)-2,2-propane or bis(4-amino-3-methylcyclohexyl)-2,2-propane.

Useful diamines further include 1,3- or 1,4-cyclohexanediamine or isophoronediamine. In addition to the units which derive from terephthalic acid and hexamethylenediamine, partly aromatic copolyamides comprise units derived from ε-caprolactam, and/or units derived from adipic acid and hexamethylenediamine.

The proportion of units derived from ε-caprolactam is up to 50 wt %, preferably from 20 to 50 wt %, in particular from 25 to 40 wt %, while the proportion of units derived from adipic acid and hexamethylenediamine is up to 60 wt %, preferably from 30 to 60 wt %, and in particular from 35 to 55 wt %.

The copolyamides may also comprise not only units of ε-caprolactam but also units of adipic acid and hexamethylenediamine, in this case it should be ensured that the proportion of units which are free of aromatic groups is at least 10 wt %, preferably at least 20 wt %. In this case there is no particular limit to the ratio of units which derive from ε-caprolactam and from adipic acid and hexamethylenediamine.

There are many applications for which polyamides comprising 50 to 80, in particular 60 to 75 wt % of units derived from terephthalic acid and hexamethylenediamine and 20 to 50, preferably 25 to 40 wt % of units derived from ε-caprolactam will prove particularly advantageous. Partly aromatic copolyamides are obtainable for example by the methods described in EP-A 0 129 195 and EP-A 0 129 196.

Preferred partly aromatic polyamides are those which a content of triamine units, in particular units of dihexamethylenetriamine of below 0.555 wt %, i.e., from 0 to 0.554 wt %, preferably from 0 to 0.45 wt %, more preferably from 0 to 0.3 wt %. Linear polyamides having a melting point above 200° C. are preferred.

Preferred polyamides are polyhexamethyleneadipamide, polyhexarnethylenesebacamide and polycaprolactam and also nylon 6/6T and nylon 66/6T and also polyamides comprising cyclic diamines as comonomers. Polyamides in general have a relative viscosity in the range from 2.0 to 5, as determined on a 1 wt % solution in 96 wt % sulfuric acid at 23° C., which corresponds to a molecular weight (number average) of about 15 000 to 45 000. Polyamides having a relative viscosity of 2.4 to 3.5, in particular 2.5 to 3.4, are used with preference.

There may additionally also be mentioned polyamides as obtainable, for example, by condensation of 1,4-diaminobutane with adipic acid at elevated temperature (nylon-4,6). Methods of making polyamides with this structure are described for example in EP-A 038 094, EP-A 038 582 and EP-A 039 524.

Component B:

Component B of the thermoplastic molding compositions according to the present invention comprises one or more styrene copolymers. Any suitable comonomers may be present in these copolymers as well as styrene. It is preferable for a styrene-acrylo-nitrile copolymer, an alpha-methylstyrene-acrylonitrile copolymer or an N-phenyl-maleimide-styrene copolymer to be concerned.

Component B is comprised in the molding compositions in an amount of 3 to 91.8 wt %, often 10 to 75 wt %. Component B amounts in the molding compositions of 10 to 20 wt % will also be found advantageous.

Any styrene-acrylonitrile, α-methylstyrene-acrylonitrile, N-phenylmaleimide-acrylonitrile copolymers, and mixtures thereof, that are known to a person skilled in the art and are described in the literature can in principle be used as component B provided their mixtures have a viscosity number VN (as measured to German standard specification DIN 53727 at 25° C. on a 0.5 wt % solution in dimethylformamide; this method of measurement also holds for any hereinbelow recited viscosity numbers VN) of not more than 85 ml/g.

Preferred components B are constructed from 50 to 90 wt %, preferably 60 to 85 wt %, in particular 70 to 83 wt %, of styrene and 10 to 50 wt %, preferably 15 to 40 wt %, in particular 17 to 30 wt %, of acrylonitrile and also 0 to 5 wt %, preferably 0 to 4 wt %, in particular 0 to 3 wt %, of further monomers, wherein the wt % are each based on the weight of the components in copolymer B and add up to 100 wt %.

Preferred components B are further constructed from 50 to 90 wt %, preferably 60 to 80 wt %, in particular 65 to 78 wt %, of α-methylstyrene and 10 to 50 wt %, preferably 20 to 40 wt %, in particular 22 to 35 wt %, of acrylonitrile and also 0 to 5 wt %, preferably 0 to 4 wt %, in particular 0 to 3 wt %, of further monomers, wherein the wt % are each based on the weight of the components in copolymer B and add up to 100 wt %.

Similarly preferred components B are mixtures of these styrene-acrylonitrile copolymers and α-methylstyrene-acrylonitrile copolymers with N-phenylmaleimide-styrene-acrylonitrile terpolymers N-phenylmaleimide-styrene copolymers.

The further monomers referred to above can be any copolymerizable monomers, for example p-methylstyrene, t-butylstyrene, vinylnaphthalene, alkyl acrylates and/or alkyl methacrylates, for example those with C1-C₈ alkyl, N-phenylmaleimide and mixtures thereof.

The copolymers of component B are obtainable by known methods. For instance, they are obtainable by free-radical polymerization, in particular by emulsion polymerization, suspension polymerization, solution polymerization or bulk polymerization. They have viscosity numbers in the range from 40 to 160 ml/g, which corresponds to average molecular weights Mw (weight-average value) of 40 000 to 2 000 000 g/mol.

Component C:

Component C comprises elastomeric graft copolymers of vinylaromatic compounds, in particular of styrene, and vinyl cyanides, in particular acrylonitrile, on poly(alkyl acrylate) rubbers.

Component C is comprised in the molding compositions in an amount of 3 to 91.8 wt %, preferably 10 to 50 wt %, more preferably in an amount of 15 to 40 wt %. Component C is also often employed at from 20 to 25 wt %.

One way to characterize the extent of the crosslinking in crosslinked particles of polymer is to measure the swelling index SI which, according to the literature, is a measure of the degree to which a more or less crosslinked polymer is swellable by a solvent. Methyl ethyl ketone and toluene are examples of customary swelling agents. Graft copolymer C of the molding compositions according to the present invention typically has an SI in the range SI=10 to 60. The SI is preferably in the range from 6 to 18 and more preferably in the range from 7 to 15 (in toluene). To determine the swelling index, an aqueous dispersion of graft copolymer C is dried at 80° C. overnight on a metal sheet under slightly reduced pressure (600 to 800 mbar) and nitrogen, leaving a film about 2 mm in thickness. A 1 cm² slice is then out off and swollen overnight in 50 ml of toluene (or methyl ethyl ketone) in a penicillin bottle. Supernatant toluene is removed by suction, and the swollen film is weighed and dried at 80° C. overnight. The weight of the dried film is determined. The swelling index is calculated by dividing the weight of the swollen gel by the weight of the dried gel.

In one preferred embodiment, the elastomeric graft copolymer C is constructed from:
C1 1 to 99 wt %, preferably 55 to 80 wt %, in particular 55 to 65 wt %, of a particulate grafting base C1, having a glass transition temperature below 0° C., and
C2 99 to 1 wt %, preferably 45 to 20 wt %, in particular 45 to 35 wt %, of a graft C2, having a glass transition temperature above 30° C.,
based on C.

Component C1 therein is constructed from:
C11 60 to 99.98 wt %, preferably 80 to 99.9 wt %, of at least one C₁₋₈alkyl ester of acrylic acid, preferably C₄-C₈ alkyl acrylates, in particular n-butyl acrylate and/or 2-ethylhexyl acrylate, as component C-11.
C12 0.01 to 20 wt %, preferably 0.1 to 5 wt %, of at least one polyfunctional crosslinking monomer, preferably butylene diacrylate, divinylbenzene, butaynediol dimethacrylate, trimethylolpropane tri(meth)acrylate, diallyl methacrylate, diallyl maleate, diallyl fumarate, triallyl methacrylate, triallyl isocyanurate, more preferably diallyl phthalate, allyl methacrylate and/or dihydrodicyclopentadienyl acrylate (“DCPA”), and
C13 0.01 to 39.99 wt %, preferably 0 to 19.9 wt %, of monomers forming hard polymers, such as vinyl acetate, (meth)acrylonitrile, styrene, substituted styrene, methyl methacrylate or vinyl ether.

Component C2 therein is constructed from:
C-21 40 to 100 wt %, preferably 65 to 85 wt % of a vinylaromatic monomer, in particular of styrene, of α-methylstyrene or of N-phenylmaleimide, and
C-22 0 to 60 wt %, preferably 15 to 35 wt % of a polar copolymerizable ethylenically unsaturated monomer, in particular of acrylonitrile, (meth)acrylic ester or of methacrylonitrile.

Component C comprises a graft copolymer comprising a grafting base C1 and at least one graft C2. Graft copolymer C may have a more or less perfectly developed core-shell construction (grafting base C1 is the core, graft C2 is the shell), but it is also possible for graft C2 to enclose/cover grafting base C1 only incompletely or alternatively for grafting base C1 to be wholly or partly interpenetrated by graft C2.

Grafting base C1 in one embodiment of the invention may comprise a so-called core, which may be formed from a soft elastomeric polymer or a hard polymer; in various embodiments where grafting base C1 comprises a core, the core is preferably formed from a hard polymer, in particular polystyrene or a styrene copolymer. Such grafting cores and their method of making are known to a person skilled in the art and are described for example in EP-A 535 456 and EP-A 534 212.

It is also possible to employ two or more grafting bases C1 that differ from each other, for example, in their composition or in particle size. Such mixtures of different grafting bases are obtainable in a conventional manner, for example by producing two or more rubber latices separately and mixing the corresponding dispersions; precipitating the moist rubbers separately from the corresponding dispersions and mixing them, for example, in an extruder; or performing the entire work-up of the corresponding dispersions separately and then mixing the grafting bases obtained.

Graft copolymer C may include at a point between grafting base C1 and graft C2 one or more further grafts, or grafted sheaths or shells, for example having different lineups of monomer. Preferably, however, graft copolymer C aside from graft C2 includes no further grafts or grafted sheaths or shells.

The polymer of grafting base C1 typically has a glass transition temperature below 0°, preferably a glass transition temperature below (−20)° C., in particular below (−30)° C. A polymer formed from the monomers which form graft C2 typically has a glass transition temperature of more than 30° C., in particular more than 50° C. (each determined to German standard specification DIN 53765).

Graft copolymers C typically have an average particle size d₅₀ in the range from 50 to 1200 nm, preferably in the range from 50 to 800 nm and more preferably in the range from 50 to 600 nm. These particle sizes are obtainable by using average particle sizes d₅₀ in the range from 50 to 1000 nm, preferably in the range from 50 to 700 nm and more preferably in the range from 50 to 500 nm as grafting base C1.

In one embodiment of the invention, the particle size distribution is monomodal. In a further embodiment of the invention, the particle size distribution of component C is bimodal in that from 60 to 90 wt % is of an average particle size in the range from 50 to 200 nm and from 10 to 40 wt % is of an average particle size in the range from 200 to 800 nm, based on the overall weight of component C. The particle size distribution and the average particle size reported herein are determined from the cumulative mass-based distribution. These average particle sizes and the further average particle sizes recited in the context of the present invention are in all cases the weight averages of the particle sizes as determined via HDC (see W. Wohlleben and H. Schuch in Measurement of Particle Size Distribution of Polymer Latexes, 2010, Editors: Luis M. Gugliotta and Jorge R. Vega, pp. 130 to 153).

Graft copolymers C are obtainable by graft polymerization of components C-21 and C-22 onto at least one of grafting bases C1 recited above. Emulsion polymerization, solution polymerization, bulk polymerization and suspension polymerization are suitable methods of making graft copolymers C. Graft copolymers C are preferably made by free-radical emulsion polymerization in the presence of latices of component C1 at temperatures of 20 to 90° C. by using water-soluble or oil-soluble initiators such as peroxodisulfate or benzyl peroxide, or by means of redox initiators. Redox initiators are also useful for polymerization below 20° C.

Suitable methods of polymerization are described in WO 2002/10222, DE-A 28 26 925, DE-A 31 49 358 and DE-C 12 60 135. The grafts are preferably constructed by emulsion polymerization as described in DE-A 32 27 555, DE-A 31 49 357, DE-A 31 49 358, DE-A 34 14 118. The defined adjustment of the average particle sizes to the range from 50 to 1200 nm is preferably made according to the methods described in DE-C 12 60 135 and DE-A 28 26 925, and/or Applied Polymer Science, volume 9 (1965), page 2929.

Usage of polymers having different particle sizes is known, for example, from DE-A-28 26 925 and U.S. Pat. No. 5,196,480. In the method described in DE-B-12 60 135, the first step comprises preparing grafting base C1 by polymerizing the C-11 acrylic ester(s) used in one embodiment of the invention and the C-12 compound acting as crosslinking and/or grafting reagent, optionally together with further monoethylenically unsaturated monomers C-13, in an aqueous emulsion in a conventional manner at temperatures between 20 and 100° C., preferably between 50 and 90° C.

Customary emulsifiers can be used, examples being alkali metal salts of alkyl- and alkylaryl sulfonic acids, alkyl sulfates, fatty alcohol sulfonates, salts of higher fatty acids having 10 to 30 carbon atoms or resin soaps. Preference is given to using the sodium salts of alkyl sulfonates or fatty acids having 10 to 18 carbon atoms. In one embodiment, emulsifiers are employed in amounts of 0.5 to 5 wt %, in particular of 0.7 to 2 wt %, based on the monomers employed in the preparation of grafting base C1. The weight ratio of water to monomers is generally in the range from 4:1 to 0.6:1. Useful polymerization initiators include particularly the customary persulfates, for example potassium persulfate.

Redox systems can also be employed, however. The initiators are generally employed in amounts of 0.1 to 1 wt %, based on the monomers used in the preparation of grafting base C1. Useful polymerization assistants further include the customary buffering substances to adjust the pH to the preferred range from 6 to 9, such as sodium bicarbonate and sodium pyrophosphate, and also from 0 to 3 wt % of a molecular weight controller, such as mercaptans, terpinols or dimeric α-methylstyrene.

Precise polymerization conditions, in particular emulsifier type, feed modus and quantity, are specifically determined within the above-specified ranges such that the resultant latex of crosslinked acrylic ester polymer C1 has a d₅₀ value in the range from 50 to 1000 nm, preferably in the range from 50 to 700 nm and more preferably in the range from 50 to 500 nm. And the particle size distribution of the latex shall preferably be narrow, with a polydispersity index <0.75, in line with W. Mächtle and L. Börger, Analytical Ultracentrifugation of Polymers and Nanoparticles, (Springer, Berlin, 2006),

To form graft polymer C, one embodiment of the invention may comprise a subsequent step wherein the latex thus obtained for crosslinked acrylic ester polymer C1 is present as a monomer mixture of component C-21, preferably styrene, component C-22, preferably acrylonitrile and/or a (meth)acrylic ester, and optionally further unsaturated monomers is polymerized. Monomers C-21, C-22 and optionally further unsaturated monomers may be added to this polymerization individually or in admixture with one another. One possible example is to graft initially styrene alone and thereafter a mixture of styrene and acrylonitrile. It is advantageous for this graft copolymerization onto the crosslinked acrylic ester polymer grafting base to be again carried out in aqueous emulsion under the customary conditions as described above.

The graft copolymerization may be conveniently carried out in the same system as the emulsion polymerization to form grafting base C1, in which case further emulsifier and initiator can be added, if necessary. The monomer mixture to be grafted onto the grafting base in one embodiment of the invention may be added to the reaction mixture all at once, batchwise in two or more stages—for example to construct two or more grafts—or preferably continuously during the polymerization. The graft copolymerization of the mixture of components C-21, C-22 and optionally further monomers in the presence of acrylic ester polymer C1 to be crosslinked is conducted such that graft copolymer C has a degree of grafting in the range from 10 to 70 wt %, preferably in the range from 20 to 60 wt % and in particular in the range from 30 to 55 wt %, based on the overall weight of component C. Since the grafting yield of a graft copolymerization is never 100%, a somewhat larger amount of the monomer mixture of C-21, C-22 and optionally further monomers should advantageously be used in the graft copolymerization than corresponds to the desired degree of grafting.

Controlling the grafting yield in a graft copolymerization and thus the degree of grafting for final graft copolymer C is familiar to a person skilled in the art and may be accomplished for example via the monomer feed rate or via admixture of chain transfer agents (Chauvel, Daniel, ACS Polymer Preprints 15 (1974), pages 329 to 333). An emulsion graft copolymerization will generally give rise to from 5 to 15 wt %, based on the graft copolymer, of free, ungrafted copolymer of components C-21, C-22 and optionally the further monomers. The proportion of graft copolymer C in the polymerization product obtained in the graft copolymerization can be determined for example by the method described in US 2004/0006178.

In further embodiments of the processes according to the present invention, grafting base C1 may be formed in the presence of seed particles and/or an agglomeration step may be carried out after formation of grafting base C1 and before application of graft C2. These two processing options are known to a person skilled in the art and/or described in the literature, and are chosen for example in order that particle sizes and particle size distributions may be adjusted in a specific manner.

The d₅₀ size of seed particles is generally in the range from 10 to 200 nm, preferably in the range from 10 to 180 nm and more preferably in the range from 10 to 160 nm. The employment of seed particles having a particle, size distribution of low width is preferred. Particularly preferred seed particles thereamong have a monomodal particle size distribution. The seed particles may in principle be constructed from monomers that form elastomeric polymers, examples of such monomers being 1,4-butadiene or acrylates, or from a polymer whose glass transition temperature is more than 0° C., preferably more than 25° C. Preferred monomers for basing these seed particles include vinylaromatic monomers such as styrene, ring-substituted styrenes or α-methylstyrene, including preferably styrene, acrylonitrile, alkylacrylic acid, alkyl acrylates, including preferably n-butyl acrylate. Mixtures of two or more, preferably exactly two, of the monomers mentioned are also suitable. Seed particles from polystyrene or n-butyl acrylate are very particularly preferred.

The preparation of seed particles of this type is known to a person skilled in the art or can be carried out according to methods known per se. The seed particles are preferably obtained by particle-forming heterogeneous methods of polymerization, preferably by emulsion polymerization. The seed particles are initially charged according to the present invention for which it is possible for the seed particles to be first separately prepared, worked up and than used. But it is also possible for the seed particles to be formed and then, without prior workup, to be admixed with the monomer mixture of C-11, C-12 and optionally C-13.

Processes for partial or complete agglomeration of grafting base C1 are known to a person skilled in the art. Agglomeration can be carried out according to methods known per se to a person skilled in the art (see for instance Keppler et al. Angew. Markomol. Chemie, 2, 1968 No. 20, pages 1 to 25).

The agglomeration method is not subject to any in-principle limitation. Physical methods such as freeze agglomeration or pressure agglomeration processes can thus be used. But chemical methods can also be used to agglomerate the grafting base. Chemical methods include the admixture of electrolytes or of organic or inorganic acids.

Preference is given to agglomeration by means of an agglomeration polymer. Examples of agglomeration polymers are polyethylene oxide polymers, polyvinyl ethers or polyvinyl alcohols. Suitable agglomeration polymers further include copolymers comprising C₁-C₁₂ alkyl acrylates or C₁-C₁₂ alkyl methacrylates or polar comonomers such as acrylamide, methacrylamide, ethylacrylamide, n-butylacrylamide, maleamide or (meth)acrylic acid. These monomers aside, these copolymers can also be constructed from further monomers, including dienes such as butadiene or isoprene. Agglomeration polymers can have a multistage construction and can have, for example, a core/shell construction.

The core may be, for example, a polyacrylate such as polyethyl acrylate, while the shell may be particles on alkyl (meth)acrylates and the polar comonomers mentioned. A particularly preferred agglomeration polymer is a copolymer formed from 92 to 99 wt % of ethyl acrylate or methacrylate and 1 to 8 wt % of (meth)acrylamide and/or (meth)acrylic acids. Agglomeration polymers are generally used in the form of a dispersion. The agglomeration process utilizes in general from 0.1 to 5, preferably from 0.5 to 3, parts by weight of the agglomeration polymers per 100 parts by weight of the grafting base.

Graft copolymers C of the present invention can be further used as obtained in the reaction mixture, for example as latex emulsion or dispersion. Alternatively—and this is preferable for most applications—they can also be worked up in a further step. Workup measures are known to a person skilled in the art. They include, for example, graft copolymers C being isolated from the reaction mixture, for example by spray drying, shearing or by precipitation with strong acids or by means of nucleating agents such as inorganic compounds, e.g., magnesium sulfate. However, as-obtained graft copolymers C can also be worked up by complete or partial dewatering. Another possibility is to work up by means of a combination of the measures referred to. The mixing of components B and C to form the molding composition can be effected in any desired manner by known methods.

When these components have been formed by emulsion polymerization, for example, it is possible for the polymer dispersions obtained to be mixed with one another, then to conjointly precipitate the polymers and to work up the polymer mixture. Preferably, however, these components are blended by being conjointly extruded, kneaded or rolled, for which the components have been isolated beforehand as necessary from the as-polymerized solution or aqueous dispersion.

However, the graft copolymerization product C obtained in aqueous dispersion can also be dewatered only partially and mixed in the form of moist crumb with the hard matrix B, in which case graft copolymers C than dry completely during the mixing.

Component D:

Component D of the molding compositions according to the present invention comprises a compound of formula (I):

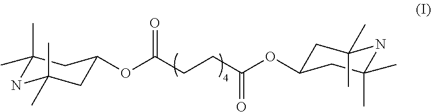

This sterically hindered amine (CAS number 52829-07-9) and its method of making are known to a person skilled in the art and described in the literature (see for example U.S. Pat. No. 4,396,769 and the literature references cited therein). It is marketed by BASF SE under the designation Tinuvin® 770.

Component D is employed in the molding compositions in an amount of 0.2 to 1.5 wt %, preferably 0.2 to 1.2 wt %, often 0.3 to 1.1 wt %.

Component E:

Component E of the molding compositions according to the present invention comprises a compound of formula (II) or a mixture of two or more compounds:

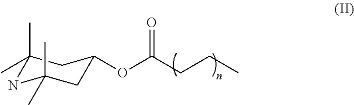

where n is 2 to 20, in particular

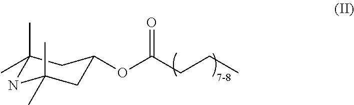

Component E is employed in the molding compositions in an amount of 0 to 0.9 wt %, preferably 0.2 to 0.8 wt %, often 0.2 to 0.7 wt %.

These sterically hindered amines, such as (CAS number 167078-06-0) and their method of making are known to a person skilled in the an and described in the literature (Carlsson et al., Journal of Polymer Science, Polymer Chemistry Edition (1982), 20(2), 575-82). It is marketed by Cytec Industries as mixture where n=7-8 under the designation Cyasorb® 3853 (CAS number 167078-06-0).

Component F:

Component F of the molding compositions according to the present invention may be a compound of formula (III) or a mixture:

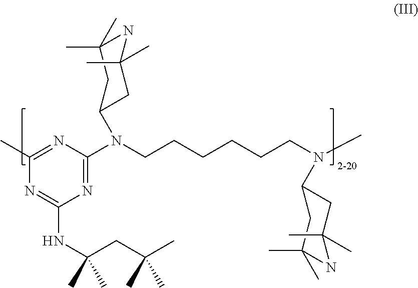

This sterically hindered amine (CAS number 71878-19-8) and its method of making are known to a person skilled in the art and described in the literature (see for example EP-A 093 693 and the literature references cited therein). It is marketed by BASF SE under the designation Chimassorb® 944.

Component F of the molding compositions according to the present invention may further be a compound of formula (IV):

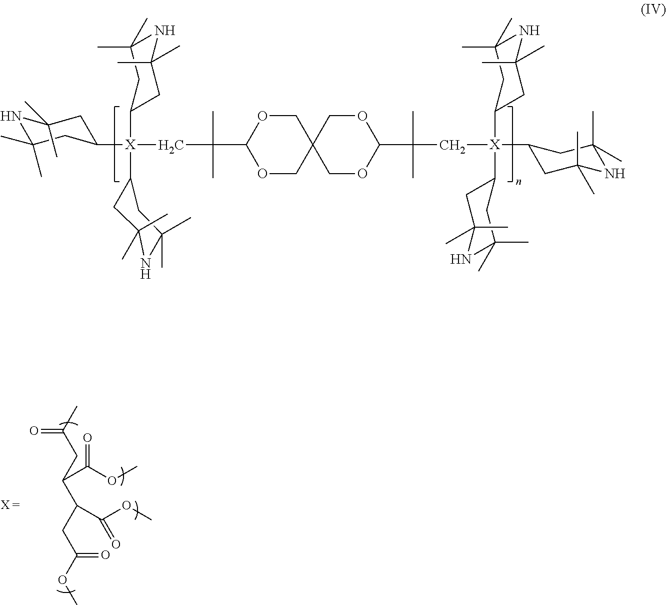

where n=2 to 20

This sterically hindered amine (CAS number 101357-37-3) and its method of making are known to a person skilled in the art and described in the literature (see for example U.S. Pat. No. 5,208,132 and the literature references cited therein). It is marketed by ADEKA under the designation Adeka Stab® LA-63.

Component F of the molding compositions according to the present invention may further be a compound of formula (V) or a mixture:

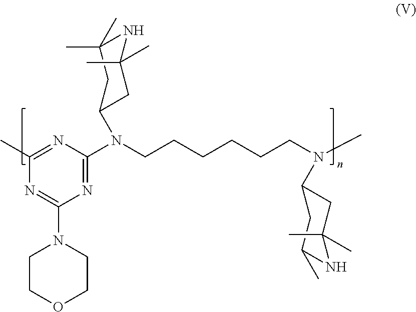

where n=2 to 20

This sterically hindered amine (CAS number 82451-48-7) and its preparation are known to a person skilled in the art and described in the literature (see for example U.S. Pat. No. 4,331,586 and the literature references cited therein). It is marketed by Cytec Industries under the designation Cyasorb® UV-3346.

Component F of the molding compositions according to the present invention may further be a compound of formula (VI) or a mixture:

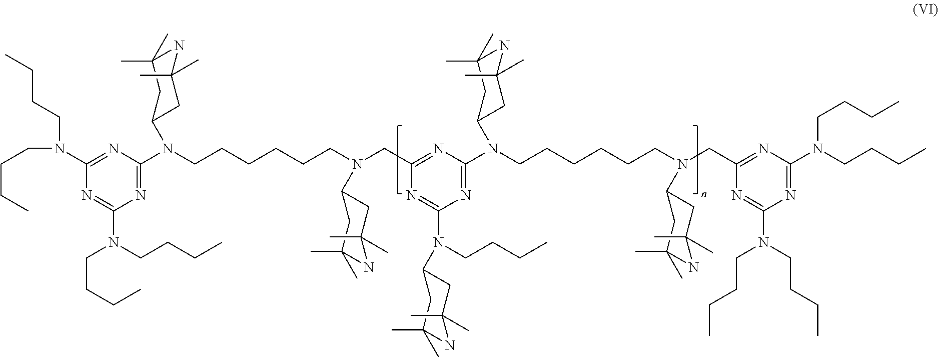

where n=2 to 20

This sterically hindered amine (CAS number 192268-64-7) and its method of making are known to a person skilled in the art and described in the literature (see for example EP-A-782 994 and the literature references cited therein). It is marketed by BASF SE under the designation Chimassorb® 2020.

Component F is employed in the molding compositions in an amount of 0 to 0.9 wt %, preferably 0.1 to 0.8 wt %, often 0.2 to 0.8 wt %.

Component G:

Component G of the thermoplastic molding compositions of the present invention comprises styrene copolymers which, based on overall component G, include from 0.5 to 5 wt %, preferably 1 to 2.5, in particular 1.9 to 2.3 wt % of maleic anhydride-derived units. This proportion is with particular preference in the range from 2 to 2.2 wt % and is specifically about 2.1 wt %.

It is particularly preferable for component G to be a styrene-acrylonitrile-maleic anhydride terpolymer or a styrene-N-phenylmaleimide-maleic anhydride terpolymer.

The proportion of acrylonitrile in the terpolymer is preferably in the range from 10 to 30 wt %, more preferably in the range from 15 to 30 wt % and in particular in the range from 20 to 25 wt %, based on the overall terpolymer. The remainder comprises styrene.

The copolymers generally have molecular weights M_{W} in the range from 30 000 to 500 000 g/mol, preferably from 50 000 to 250 000 g/mol, particularly from 70 000 to 200 000 g/mol, as determined by GPC using tetrahydrofuran (THF) as eluent and with polystyrene calibration. The copolymers are obtainable by free-radical polymerization of the corresponding monomers. Their preparation is more particularly explicated for example in WO 2005/040281, page 10, line 31 to page 11, line 8.

It is further also possible to use styrene-N-phenylmaleimide-maleic anhydride terpolymers. Reference can further be made to the descriptions in EP-A 0 784 080 and also DE-A 100 24 935, and also to DE-A 44 07 485, description of component B there on pages 6 and 7.

Component G is employed in the molding compositions in an amount of 1 to 25 wt %, preferably 2 to 10 wt %, often 3 to 7 wt %.

Component H:

Component H of the thermoplastic molding compositions according to the present invention comprises further rubbers. The further rubber(s) are based on olefinic monomers without core-shell construction and comprise not less than 0.1 wt % of functional monomers. By “based on” is meant that the largest proportion of the rubber derives from olefinic monomers (not less than 60 wt %, preferably not less than 80 wt %, in particular not less than 90 wt %). The rubber comprises not less than 0.1 wt % of functional monomers. Functional monomers are monomers comprising a functional group, which are more particularly capable of forming bonds with the polyamide of component A. The bonds formed are preferably covalent bonds. The functional groups in the functional monomers are preferably selected from carboxylic acid, carboxylic anhydride, carboxylic ester, carboxamide, carboximide, amino, hydroxyl, epoxy, urethane or oxazoline groups or mixtures thereof.

Component H is employed in the molding compositions in an amount of 1 to 30 wt %, preferably 1.5 to 10 wt %, often 2 to 5 wt %.

Component H is preferably a copolymer formed from the following components:
h1) 35 to 89.95 wt % of ethylene, as component H1,
h2) 10 to 60 wt % of 1-octene, 1-butene, propene or mixtures thereof, as component H2, and
h3) 0.05 to 5 wt % of functional monomers, wherein the monomers bear functional groups selected from carboxylic acid, carboxylic anhydride, carboxylic ester, carboxamide, carboximide, amino, hydroxyl, epoxy, urethane or oxazoline groups or mixtures thereof, as component H3.

The proportion of functional groups H3 is from 0.1 to 5, preferably 0.2 to 4 and in particular from 0.3 to 3.5 wt %, based on the overall weight of component H.

Particularly preferred components H3 are constructed from an ethylenically unsaturated mono- or dicarboxylic acid or from a functional derivative of such an acid.

All primary, secondary and tertiary C₁-C₁₈ alkyl esters of acrylic acid or of methacrylic acid are suitable in principle, but esters having 1 to 12 carbon atoms, in particular 2 to 10 carbon atoms are preferred. Examples thereof are methyl acrylate, ethyl acrylate, propyl acrylate, n-butyl acrylate, isobutyl acrylate, tert-butyl acrylate, 2-ethylhexyl acrylate, octyl acrylate, decyl acrylate, methyl methacrylate, ethyl methacrylate, propyl methacrylate, n-butyl methacrylate, isobutyl methacrylate, tert-butyl methacrylate, 2-ethylhexyl methacrylate, octyl methacrylate and decyl methacrylate. Of these, n-butyl acrylate and 2-ethylhexyl acrylate are particularly preferred.

Instead of esters or in addition thereto, the olefin polymers may also comprise acid-functional and/or latently acid-functional monomers ethylenically unsaturated mono- or dicarboxylic acids or epoxy-containing monomers. Useful monomers H3 further include, for example, acrylic acid, methacrylic acid, tertiary alkyl esters of these acids, in particular tert-butyl acrylate and dicarboxylic acids such as maleic acid and fumaric acid or derivatives of these acids and also monoesters thereof.

Latently acid-functional monomers are compounds that form free acid groups under the polymerization conditions and/or on incorporating the olefin polymers into the molding compositions. Examples thereof are anhydrides of dicarboxylic acids having up to 20 carbon atoms, in particular maleic anhydride and tertiary C₁-C₁₂ alkyl esters of the aforementioned acids, in particular tert-butyl acrylate and tert-butyl methacrylate.

The acid-functional or latently acid-functional monomers and the epoxy-containing monomers are preferably incorporated in the olefin polymers by admixture of compounds of general formulae VIII-XI to the monomer mixture.

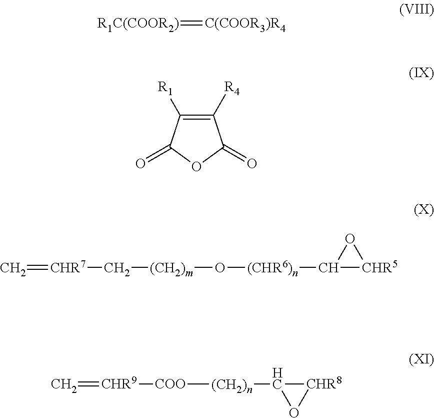

where R¹ to R⁴ and R⁵ to R⁹ are each hydrogen or alkyl of 1 to 6 carbon atoms, m is an integer from 0 to 20 and n is an integer from 0 to 10. Preferably, R¹ to R⁴ and R⁵ to R⁷ are each hydrogen, m is 0 or 1 and n is 1. The corresponding compounds are maleic acid, fumaric acid, maleic anhydride and alkenyl glycidyl ether or vinyl glycidyl ether.

Preferred compounds of formulae VIII, IX, X and XI are maleic acid and maleic anhydride as component H3 and epoxy-containing esters of acrylic acid and/or methacrylic acid, where glycidyl acrylate and glycidyl methacrylate are particularly preferred (as component H3).

Particular preference is given to olefin polymers constructed from:

50 to 89.8 wt % of ethylene, preferably 55 to 85.7,

10 to 50 wt % of 1-butene, preferably 14 to 44,

0.2 to 2 wt % of acrylic acid or maleic acid or meloio an preferably from 0.3 to

1 wt %,

or constructed from:

40 to 69.9 wt %, preferably 50 to 64.9 wt % of ethylene,

30 to 60 wt %, preferably 35 to 49 wt % of 1-octene,

0.05 to 2 wt %, preferably from 0.1 to 1 wt % of acrylic acid or maleic acid or maleic anhydride.

The ethylene copolymers described above are obtainable in a conventional manner, preferably by random copolymerization under high pressure and elevated temperature. These ethylene-α-olefin copolymers have a molecular weight between 10 000 and 500 000 g/mol, preferably between 15 000 and 400 000 g/mol (Mn, determined via GPC in 1,2,4-trichlorobenzene with PS calibration).

A special embodiment employs ethylene-α-olefin copolymers formed using single site catalysts. Further details are available in U.S. Pat. No. 5,272,236. In this case, the molecular weight distribution of the ethylene-α-olefin copolymers is below 4, preferably below 3.5, and so is narrow for polyolefins.

Preferred commercial products for use as component H are Exxelor® VA 1801 or 1803, Kraton® G1801 FX or Fusabond® N NM493 D from Exxon, Kraton and DuPont and also Tafmer® MH 7010 from Mitsui and also Lupolen® KR 1270 from BASF SE. Mixtures of the just recited types of rubber can also be employed.

The functionalized rubbers of component H react in the melt with component A and become finely dispersed therein. Particular preference is given to EP rubbers with acrylic acid or maleic anhydride grafting, ethylene-acrylic acid copolymers, ethylene-octene copolymers with maleic anhydride grafting, SEBS rubbers grafted with maleic anhydride and also ethylene-butene copolymers grafted with maleic anhydride or with acrylic acid.

Component I:

In addition to components A, B, C, D, E, F, G and H, the molding compositions according to the present invention may comprise one or more additives/added-substance, materials other than components D, E, F, G and H and as typical and customary for mixtures of plastics.

Examples of such additives/added-substance materials are: dyes, pigments, colorants, antistats, antioxidants, stabilizers to improve thermal stability, to enhance hydrolysis resistance and chemical resistance, agents against thermal decomposition and in particular the lubricants/glidants that are useful for production of moldings and/or molded articles.

These further added-substance materials may be admixed at every stage of the manufacturing operation, but preferably at an early stage in order to profit early on from the stabilizing effects (or other specific effects) of the added-substance material. Heat stabilizers and oxidation retarders are typically metal halides (chlorides, bromides, iodides) and are derived from metals of group I of the periodic table (such as Li, Na, K, Cu).

Stabilizers useful as component I include the customary hindered phenols, but also “vitamin E” and/or similarly constructed compounds. Benzophenones, resorcinols, salicylates, benzotriazoles and other compounds are also suitable. These are typically used in amounts of 0 to 2 wt %, preferably 0.01 to 2 wt % (based on the overall weight of molding compositions according to the present invention). Often the molding compositions contain no stabilizers as component I.

Suitable gliding and demolding agents include stearic acids, stearyl alcohol, stearic esters and/or generally higher fatty acids, their derivatives and corresponding fatty acid mixtures having 12 to 30 carbon atoms. Use levels for these additions—if present—range from 0.05 to 1 wt % (based on the overall weight of molding compositions according to the present invention).

Useful added-substance materials further include silicone oils, oligomeric isobutylene or similar materials, typical usage levels—if present—ranging from 0.05 to 5 wt % (based on the overall weight of molding compositions according to the present invention). Pigments, dyes, color brighteners, such as ultramarine blue, phthalocyanines, titanium dioxide, cadmium sulfides, derivatives of perylenetetracarboxylic acid can likewise be used.

Processing aids and stabilizers, lubricants and antistats are typically used in amounts of 0 to 2 wt %, preferably 0.01 to 2 wt % (based on the overall weight of molding compositions according to the present invention).

Component J:

Component J of the molding compositions according to the present invention may comprise fibrous or particulate fillers (or mixtures thereof) other than components D, E, F, G, H and I. It is preferable for commercially available products to be concerned here, for example carbon fibers and glass fibers. Usable glass fibers may be of E-, A- or C-glass, and are preferably finished with a sizing agent and a coupling agent. Their diameter is generally between 6 and 20 μm. Not only continuous-filament fibers but also chopped glass fibers (staple) or rovings having a length of 1 to 10 mm, preferably 3 to 6 mm, can be used.

It is further possible for filling and reinforcing materials, such as glass beads, mineral fibers, whiskers, alumina fibers, mica, quartz flour and wollastonite, to be added.

In addition to components A, B, C, D, E, F, G, H and optionally I and J, the molding compositions according to the present invention may comprise further polymers.

The process of producing the molding compositions of the present invention from the components can be carried out in any desired manner by any known method. Preferably, however, the components are blended by melt mixing, for example conjoint extrusion, kneading or rolling of the components, for example at temperatures in the range from 160 to 400° C., preferably from 180 to 280° C., wherein, in a preferred embodiment, the components have first been partially or completely isolated from the reaction mixtures obtained in the particular steps of the production process. For example, graft copolymers C can be mixed in the form of moist crumb with pellets of vinylaromatic copolymer B, in which case complete drying to the graft copolymers described then takes place during mixing. The components may be supplied, each in pure form, to suitable mixing devices, in particular extruders, preferably twin-screw extruders. However, individual components, for example B and C, can also be first premixed and then mixed with further components B or C or other components, for example D and E.

Component B may be employed as a component which is produced separately beforehand; however it is also possible for the acrylate rubber and the vinylaromatic copolymer to be dosed independently from one another. In one emodiment, a concentrate, for example of components C and D in component B, is prepared first (to obtain a masterbatch or an additive batch) and then mixed with the desired amounts of the remaining components.

The molding compositions may be processed by methods known to those skilled in the art to form pellets, for example, or else be processed directly to form molded articles, for example.

The molding compositions of the present invention may be processed to form self-supporting films or sheets, molded articles or fibers. These self-supporting films or sheets, molded articles or fibers are suitable for use in particular in the outdoor sector, i.e., under weathering conditions.

These self-supporting films or sheets, molded articles or fibers are obtainable from the molding compositions of the present invention by the known methods of thermoplastic processing. More particularly, their production can take the form of thermoforming, extrusion, injection molding, calendering, blow molding, compression molding, press sintering, deepdrawing or sintering, preferably by injection molding.

The molding compositions of the present invention versus the known stabilized molding compositions have a further improved resistance to weathering, i.e., a further improved resistance to heat, light and/or oxygen.

The examples which follow and the claims elucidate the invention.

A) The Methods of Measurement:

Notched impact strength of products was determined at room temperature on ISO bars to ISO 179 1eA.

Heat resistance of samples was determined as the Vicat softening temperature. The Vicat softening temperature was determined to German standard specification DIN 53 460, using a force of 49.05 N and a temperature increase of 50 K per hour, on standardized small bars.

Surface gloss of all samples was measured to German standard specification DIN 67530 at a 60° viewing angle.

To obtain a measure of weathering resistance, test specimens (60×60×2 mm, produced to ISO 294 in a family mold at a melt temperature of 260° C. and a mold temperature of 60° C.) were subjected to weatherization by xenon-arc test to ISO 4892/2, method A, outside. The samples were not subjected to any additional treatment after weatherization. Following the 1500 h weatherization time referred to in table 1 (“BWZ”), the surface was evaluated in terms of the gray scale (5: no change, 1: massive change) to ISO 105-A02 (1993).

To obtain a further measure of weathering resistance, the color space color difference ΔE of German standard specification DIN 52 336 was calculated from ΔL, Δa and Δb according to German standard specification DIN 6174.

Further, penetration or multi-axial toughness was measured on small plaques (60 mm×60 mm×2 mm) produced to the ISO 294 standard in a family mold at a melt temperature of 260° C. and a mold temperature of 60° C. to ISO 6603-2 at room temperature.

B) The Materials Used

The components or products with a prefixed “V-” are not in accordance with the present invention, they are offered for comparison.

The following were used as component A:
A-i: the polyamide used was a nylon-6, obtained from ε-caprolactam, having a viscosity number of 150 ml/g (measured in a 0.5 wt % concentration in 96 wt % sulfuric acid), commercially available, for example, from BASF SE® under the designation Ultramid® B 3.
A-ii: the polyamide used was a nylon-6, obtained from ε-caprolactam, having a viscosity number of 120 ml/g (measured in a 0.5 wt % concentration in 96 wt % sulfuric acid) and a proportion triacetonediamine of 0.16 wt %.
V-A-ii a Moplen® HP500N polypropylene commercially available from LyondellBasell Industries AF S.C.A.

V-A-iii: a Polystyrol® 158K polystyrene commercially available from BASF SE.

The following were used as components B (or V-A for comparison):
B-i: a styrene-acrylonitrile copolymer with 75 wt % of styrene and 25 wt % of acrylonitrile and a viscosity number of 80 ml/g (determined in 0.5 wt % DMF solution at 25° C.).

The following were used as component C (or V-C for comparison):
C-i: a grafted acrylate rubber synthesized as described in the invention example of EP-A-450 485, as component B-i. Component B-i was synthesized with 2 parts of dihydrodicyclopentadienyl acrylate (CAS number 12542-30-2) instead of 2 parts of tricyclodecenyl acrylate.
   C-i₁: 16 parts of butyl acrylate and 0.4 part of dihydrodicyclopentadienyl acrylate were heated under agitation to 60° C. In 150 parts of water and the presence of one part of the sodium salt of a C₁₂-C₁₈ paraffinsulfonic acid, 0.4 part of potassium persulfate, 0.3 part of sodium bicarbonate and 0.15 part of sodium pyrophosphate. 10 minutes after the start of the reaction, a mixture of 82 parts of butyl acrylate and 1.6 parts of dihydrodicyclopentadienyl acrylate was added over 3 hours. Thereafter the reaction mixture was additionally left alone for one hour. The latex obtained had a solids content of 40 wt %. The average particle size was determined as 92 nm. The particle size distribution was narrow (quotient Q=0.33).
   C-i₂: an initial charge of 2.5 parts of the latex prepared as described in C-i₁ was admixed with 50 parts of water and 0.1 part of potassium persulfate followed in the course of 3 hours by a mixture of 49 parts of butyl acrylate and 2 parts of dihydrodicyclopentadienyl acrylate and also by a solution of 0.5 part of the sodium salt of a C₁₂-C₁₈ paraffinsulfonic acid in 25 parts of water. At this stage the temperature of the initial charge was 60° C. On completion of the addition the system was postpolymerized for 2 hours. The latex obtained had a solids content of 40%. The average particle size was determined as 526 nm. The particle size distribution was narrow (quotient Q=0.16).
   C-i₃: 150 parts of the latex obtained according to C-i₂ were mixed with 20 parts of styrene and 60 parts of water and under agitation heated to 65° C. for 3 hours after addition of a further 0.03 part of potassium persulfate and 0.05 part of lauroyl peroxide. The dispersion obtained was polymerized with 20 parts of a mixture of styrene and acrylonitrile in a ratio of 75:25 for a further 4 hours and precipitated with calcium chloride solution, the precipitate was separated off, washed with water and dried in a warm stream of air. The degree of grafting of C-i was determined as 35%, the average particle size was determined as 624 nm.

The swelling index of C-i in toluene was found to be 13.6.
V-C-ii: prepared like, component C-i, except with 5 parts of dihydrodicyclopentadienyl acrylate in C-i₁ and C-i₂ instead of 2 in each case. B-I was found to have a swelling index in toluene of 4.9. The average particle size was determined as 653 nm. The particle size distribution was narrow (SI=0.14).
V-C-iii: a grafted acrylate rubber having a particle size of 1207 nm. Prepared from component C-i₂.
V-C-iii₁: an initial charge of 9.4 parts of the latex prepared as described in C-i₂ was admixed with 50 parts of water and 0.1 part of potassium persulfate followed in the course of 3 hours by a mixture of 49 parts of butyl acrylate and 2 parts of dihydrodicyclopentadienyl acrylate and also by a solution of 0.5 part of the sodium salt of a C₁₂-C18 paraffinsulfonic acid in 25 parts of water. At this stage the temperature of the initial charge was 60° C. On completion of the addition the system was postpolymerized for 2 hours. The latex obtained had a solids content of 40%. The average particle size was determined as 1065 nm.
V-C-iii₂: 150 parts of the latex obtained according to C-i₂ were mixed with 20 parts of styrene and 60 parts of water and under agitation heated to 65′C for 3 hours after addition of a further 0.03 part of potassium persulfate and 0.05 part of lauroyl peroxide. The dispersion obtained was polymerized with 20 parts of a mixture of styrene and acrylonitrile in a ratio of 75:25 for a further 4 hours and precipitated with calcium chloride solution, the precipitate was separated off, washed with water and dried in a warm stream of air. The degree of grafting of C-i was determined as 35%, the average particle size was determined as 1207 nm.

The swelling index of V-C-iii in toluene was found to be 9.

The following were used as component D (or V-D for comparison):
D-i: a compound of formula (I), commercially available from BASF SE under the designation Tinuvin° 770.
V-D-ii: a compound of formula (XII), commercially available from BASF SE under the designation Tinuvin® 765.

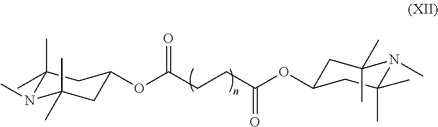

The following was used as component E (or V-E for comparison):
E-i: a compound of formula (II), commercially available from Cytec Industries under the designation Cyasorb® 3853.

The following were used as component F (or V-F for comparison):
F-i: a compound of formula (III), commercially available from BASF SE under the designation Chimassorb® 944,
F-ii: a compound of formula (V), commercially available from Cytec Industries under the designation Cyasorb® UV-3346.
V-F-iii: a high molecular weight sterically hindered amine of formula (XIII), CAS number 106990-43-6, commercially available from SABO S.p.A. under the designation Sabostab® 119

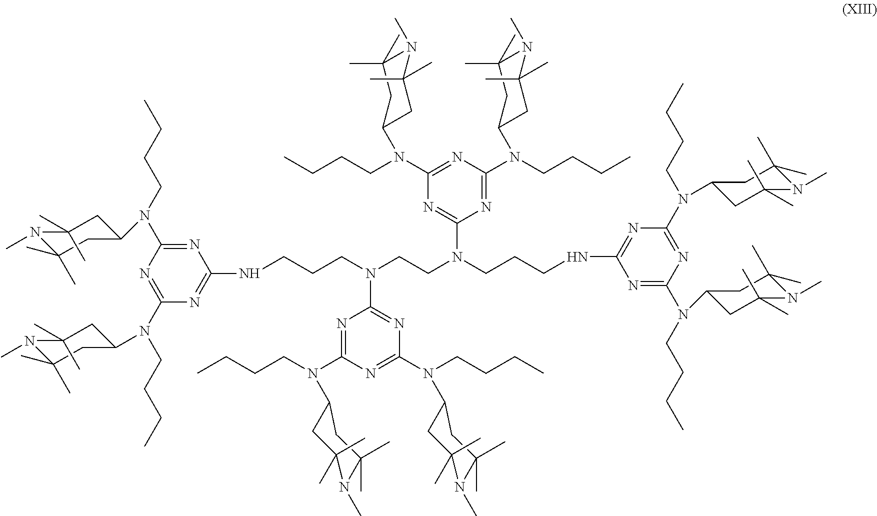

The following was used as component G:
G-i: a styrene-acrylonitrile-maleic anhydride terpolymer having a composition of 74.4 wt % of styrene, 23.5 wt % of acrylonitrile and 2.1 wt % of maleic anhydride as per infrared measurement and a viscosity number of 66 ml/g (determined in 0.5 wt % DMF solution at 25′C).

The following was used as component H:
H-i: an ethylene/1-butene copolymer with 67.9% ethylene, 31.6 wt % of butene and 0.5 wt % of maleic acid functionaiization, commercially available under the name Tafmer® MH 7010.

The following was used as component J:
J-i: Black Pearls 880 carbon black commercially available from Cabot Corporation

C) Producing the Molding Compositions and Molded Articles:

The specified components A, B, C, D, E, F, G, H and I (see table 1 for respective parts by weight) were homogenized at 280° C. In a ZSK30 twin-screw extruder (from Werner & Pfleiderer) and extruded therefrom into a water bath.

The extrudates were pelletized and dried. The pellets were used to injection mold at 260° C. melt temperature and 60° C. mold surface temperature various test specimens to determine the properties referred to in table 1 before and after weatherization.

TABLE 1
Ingredient line up and properties of molding compositions
(prefixed V: for comparison)

| Ingredient | Example | | | | | | | | | | |
|---|---|---|---|---|---|---|---|---|---|---|---|
| lineup | V-1 | 2 | 3 | 4 | 5 | V-6 | V-7 | V-8 | V-9 | V-10 | 11 |
| A-i | 51 | 51 | 51 | 51 | | | | 51 | 51 | 51 | 51 |
| A-ii | | | | | 51 | | | | | | |
| V-A-iii | | | | | | 98.8 | | | | | |
| V-A-iv | | | | | | | 98 | | | | |
| B-i | 15 | 14 | 14 | 14 | 14 | | | 14 | 14 | 14 | 14.5 |
| C-i | 24 | 24 | 24 | 24 | 24 | | | | | 24 | 24 |
| V-C-ii | | | | | | | | 24 | | | |
| V-C-iii | | | | | | | | | 24 | | |
| D-i | | 0.5 | 0.5 | 0.5 | 0.5 | 0.1 | 0.5 | 0.5 | 0.5 | | 0.5 |
| V-D-ii | | | | | | | | | | 0.5 | |
| E-i | | 0.5 | 0.25 | 0.25 | 0.5 | 0.1 | 0.5 | 0.5 | 0.5 | 0.5 | |
| F-i | | | 0.25 | | | | | | | | |
| F-ii | | | | 0.25 | | | | | | | |
| V-F-iii | | | | | | | | | | | |
| G-i | 5 | 5 | 5 | 5 | 5 | | | 5 | 5 | 5 | 5 |
| H-i | 4 | 4 | 4 | 4 | 4 | | | 4 | 4 | 4 | 4 |
| h-i | 1 | 1 | 1 | 1 | 1 | 1 | 1 | 1 | 1 | 1 | 1 |
| ak (kJ/m2) | 42 | 47 | 42 | 53 | 38 | 2 | 2 | 29 | 44 | 47 | 40 |
| Vicat B [° C.] | 115 | 113 | 114 | 113 | 115 | 86 | 101 | 115 | 114 | 113 | 115 |
| gloss | 93 | 95 | 97 | 94 | 96 | 85 | 102 | 89 | 83 | 92 | 97 |
| grayness after | | | | | | | | | | | |
| 0 h BWZ | 5 | 5 | 5 | 5 | 5 | 5 | 5 | 5 | 5 | 5 | 5 |
| 1500 h BWZ | 1 | 3 | 3.5 | 3.5 | 3 | 1 | 1 | 1.5 | 1.5 | 1 | 2 |
| ΔE after | | | | | | | | | | | |
| 0 h BWZ | 0 | 0 | 0 | 0 | 0 | 0 | 0 | 0 | 0 | 0 | 0 |
| 1500 h BWZ | 20.4 | 8.3 | 5.4 | 6.4 | 9.1 | 10.3 | 10.7 | 10.9 | 12.8 | 14.3 | 12.2 |
| penetration after | | | | | | | | | | | |
| 0 h BWZ | 36 | 35 | 33 | 33 | 28 | 4 | 2 | 19 | 32 | 34 | 37 |
| 1500 h BWZ | 3 | 9 | 10 | 9 | 7 | 1 | 1 | 4 | 5 | 3 | 5 |

These examples demonstrate that the inventive stabilized polyamide molding compositions, which also comprise a styrene copolymer component, have an improved resistance to weathering, i.e., an improved resistance to heat, light, and/or oxygen, over the known molding compositions. The ingredient lineups are reported in weight fractions, the abbreviation BWZ stands for weatherization time. Ingredient lineups comprising at least one component D (such as Tinuvin 770) and at least one component E (such as Cyasorb 3853) also prove to be particularly good.

1. A thermoplastic molding composition comprising the following components:
a) 3 to 91.8 wt % of at least one polyamide, as component A,
b) 3 to 91.8 wt % of one or more styrene copolymers without any maleic anhydride-derived units, as component B,
c) 3 to 91.8 wt % of one or more impact-modifying grafted rubbers without olefinic double bonding in the rubber phase, as component C,
d) 0.2 to 1.5 wt % of a compound of formula (I), as component D: 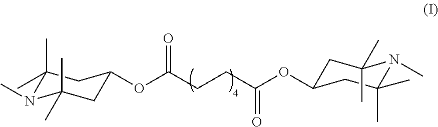
e) 0 to 0.9 wt % of a mixture of formula (II), as component E: 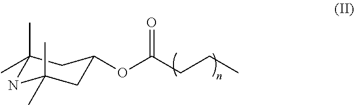
where n is 2 to 20,
f) 0 to 0.9 wt % of a compound of formula (III), as component F: 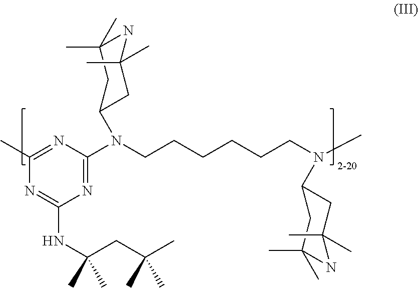
or 0 to 0.9 wt % of a compound of formula (IV): 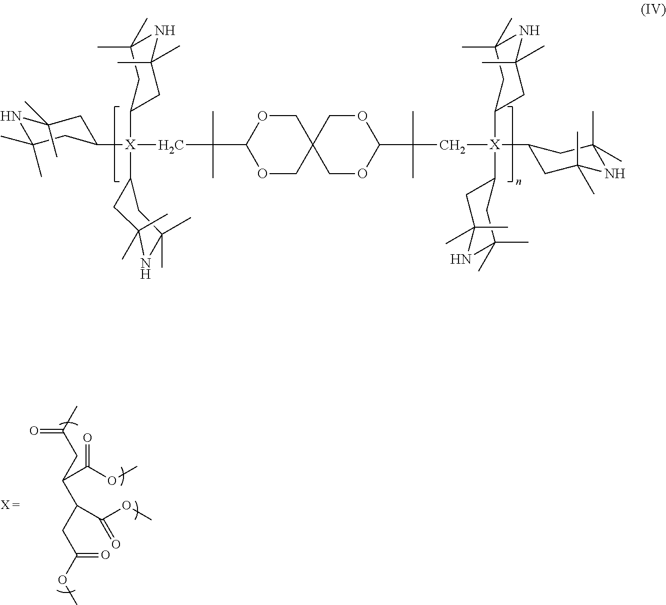
n=2 to 20
or 0 to 0.9 wt % of a compound of formula (V): 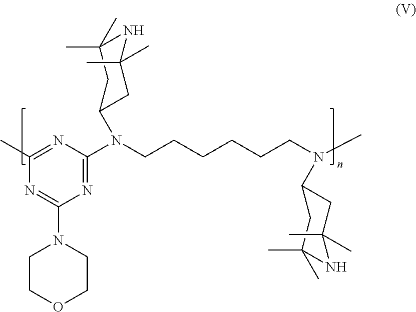
n=2 to 20
or 0 to 0.9 wt % of a compound of formula (VI): 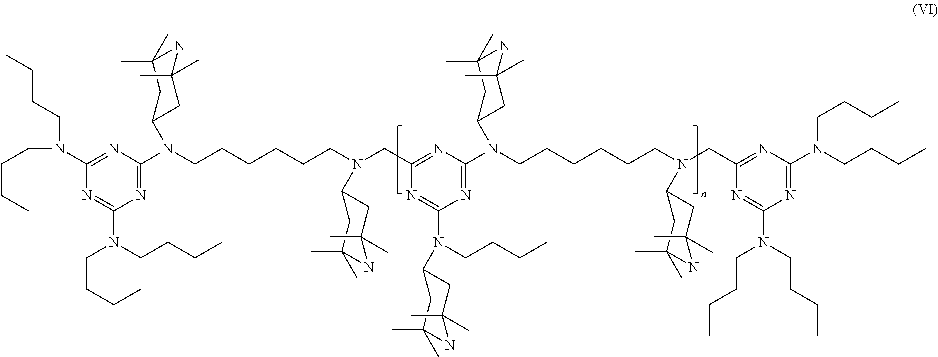
n=2 to 20
g) 1 to 25 wt % of one or more styrene copolymers which, based on overall component G, include from 0.5 to 5 wt % of maleic anhydride-derived units, as component G,
h) 1 to 30 wt % of one or more further rubbers based on olefinic monomers without core-shell construction and with at least 0.1 wt % of functional monomers, as component H,
i) 0 to 40 wt % of one or more added-substance materials other than components D, E, F, G, and H, as component I, and
0 to 40 wt % of one or more fibrous or particulate fillers, as component J,
with the proviso that when component E amounts to 0 wt %, at least one of the components of formulae (III), (IV), (V) or (VI) is present in an amount of 0.01 to 0.9 wt %, wherein the wt % are each based on the overall weight of components A to J, and these add up to 100 wt %.

2. The thermoplastic molding composition according to claim 1, characterized in that the swelling index of component C is in the range from 6 to 20.

3. The thermoplastic molding composition according to claim 1, characterized in that component B comprises a copolymer of acrylonitrile, styrene and/or α-methylstyrene, phenylmaleimide, methyl methacrylate or mixtures thereof.

4. The thermoplastic molding composition according to claim 1, characterized in that component C comprises a mixture of an acrylate-styrene-acrylonitrile (ASA) graft polymer comprising 55 to 80 wt %, based on C, of an elastomer-crosslinked acrylic ester polymer C1 and 45 to 25 wt %, based on C, of a graft sheath C2 formed from a vinylaromatic monomer and one or more polar, copolymerizable, ethylenically unsaturated monomers, optionally a further copolymerizable, ethylenically unsaturated monomer in a weight ratio of from 80:20 to 65:35.

5. The thermoplastic molding composition according to claim 1, characterized in that C1 comprises from 0.01 to 20 wt %, of a crosslinking monomer.

6. The thermoplastic molding composition according to claim 1, characterized in that the average particle diameter of component C is between 50 to 1200 nm.

7. The thermoplastic molding composition according to claim 1, characterized in that the weight ratio of components D and E is in the range from 3:1 to 1:1 and the weight ratio of components E and F is in the range from 2:1 to 0.5:1.

8. The thermoplastic molding composition according to claim 1, characterized in that component C1 comprises from 2 to 99 wt % of butyl acrylate.

9. The thermoplastic molding composition according to claim 1, characterized in that the vinylaromatic component in C2 comprises styrene or α-methylstyrene.

10. The thermoplastic molding composition according to claim 1, characterized in that the ethylenically unsaturated component in C2 comprises acrylonitrile and/or alkyl methacrylates and/or alkyl acrylates having C₁-C₈ alkyl.

11. The thermoplastic molding composition according to claim 1, characterized in that component C comprises a rubber in monomodal or bimodal particle size distribution.

12. The thermoplastic molding composition according to claim 1, characterized in that component G includes from 1.0 to 2.5 wt % of maleic anhydride-derived units.

13. The thermoplastic molding composition according to claim 1, characterized in that component G includes from 1.7 to 2.3 wt % of maleic anhydride-derived units.

14. The thermoplastic molding composition according to claim 1, characterized in that component A includes from 0.05 to 0.5 wt % of triacetonediamine (TAD) end groups.

15. The thermoplastic molding composition according to claim 1, characterized in that component H is a copolymer formed from the following components:
h1) 35 to 89.95 wt % of ethylene, as component h1,
h2) 10 to 60 wt % of 1-octene, 1-butene, propene or mixtures thereof, as component h2, and
h3) 0.05 to 5 wt % of functional monomers, wherein the monomers bear functional groups selected from carboxylic acid, carboxylic anhydride, carboxylic ester, carboxamide, carboximide, amino, hydroxyl, epoxy, urethane or oxazoline groups or mixtures thereof.

16. A process for producing a thermoplastic molding composition according to claim 1, comprising the steps of:
mixing components A, B, C, D, G and H and also, optionally, E, F, I and J with one another in any desired order at temperatures of 100 to 300° C. and a pressure of 1 to 50 bar, kneading the mixture, and extruding the kneaded mixture extruded.

17. A molded article, a fiber or a self-supporting film or sheet comprising a thermoplastic molding composition according to claim 1.

18. The thermoplastic molding composition according to claim 1 with the proviso that when component E amounts to 0 wt %, at least one of the components of formulae (III), (IV), (V) or (VI) is present in an amount of 0.1 to 0.8 wt %, wherein the wt % are each based on the overall weight of components A to J, and these add up to 100 wt %.

19. The thermoplastic molding composition according to claim 1 with the proviso that when component E amounts to 0 wt %, at least one of the components of formulae (III), (IV), (V) or (VI) is present in an amount of 0.2 to 0.8 wt %, wherein the wt % are each based on the overall weight of components A to J, and these add up to 100 wt %.

20. The thermoplastic molding composition according to claim 5, characterized in that C1 comprises from 0.1 to 5 wt %, of a crosslinking monomer selected from butylene diacrylate, divinylbenzene, butaynediol dimethacrylate, trimethylolpropane tri(meth)acrylate, diallyl methacrylate, diallyl maleate, diallyl fumarate, triallyl methacrylate, triallyl isocyanurate and mixtures thereof.
